(19) United States
(12) Patent Application Publication
(10) Pub. No.: US 2025/0031017 A1
(43) Pub. Date: Jan. 23, 2025

(54) BASE STATION, NETWORK NODE, FIRST CORE NETWORK NODE, SECOND CORE NETWORK NODE, AND A METHOD PERFORMED BY THEM

(71) Applicant: NEC Corporation, Minato-ku, Tokyo (JP)

(72) Inventors: Zhe CHEN, Tokyo (JP); Yuhua Chen, Tokyo (GB)

(73) Assignee: NEC Corporation, Minato-ku, Tokyo (JP)

(21) Appl. No.: 18/714,657

(22) PCT Filed: Dec. 6, 2022
(86) PCT No.: PCT/JP2022/044999

§ 371 Date: May 30, 2024

(30) Foreign Application Priority Data
Dec. 23, 2021 (GB) 2118978.2

(51) Int. Cl. H04W 4/06; H04L 12/18; H04W 76/12

(52) U.S. Cl. CPC H04W 4/06; H04L 12/189; H04W 76/12

(57) ABSTRACT

The present invention relates to a wireless communication system and devices thereof operating according to the 3rd Generation Partnership Project (3GPP) standards or equivalents or derivatives thereof. A method performed by a base station (5) for providing Multicast and Broadcast Services (MBS) is disclosed. The method comprises transmit, to a network node, a message including first information identifying a tunnel associated with an MBS session, wherein the message indicates that the tunnel is a shared tunnel; and receive, via the shared tunnel, user plane protocol data unit for the MBS session for transmitting to the UE (3), upon transmitting the message.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to multimedia broadcast session management in the so-called ‘5G’ (or ‘Next Generation’) systems.

### BACKGROUND ART

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present application will use the term base station to refer to any such base stations.

In the 5G architecture, the gNB internal structure may be split into two parts known as the Central Unit (CU) and the Distributed Unit (DU), connected by an F1 interface. In this ‘split’ architecture, typically ‘higher’, CU layers (for example, but not necessarily or exclusively), PDCP) and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term mobile device, user device, or UE to refer to any communication device that is able to connect to the core network via one or more base stations.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

One of the recent features being developed over the existing 5G framework is referred to as Multicast and Broadcast Services (MBS). This functionality aims to enhance 5G New Radio and 5G Core Network capabilities for a reliable, low latency, resource efficient, and massive deployment of a wide array of multicast and broadcast services. 3GPP is currently specifying the details of MBS for media distribution over mobile broadband networks. MBS (or ‘NR MBS’ in 5G) aims to reuse cellular infrastructure such as the so-called Low Power Low Tower (LPLT) infrastructure. One of the main use cases is the delivery of linear/live media content to smartphones, tablets, vehicles, and other mobile (or stationary) devices. Although MBS is designed to use existing (or already specified) 3GPP infrastructure, it can provide a more efficient delivery of multicast/broadcast traffic than unicast communication using the same infrastructure. Details of architectural enhancements for MBS may be found in the in 3GPP Technical Specification (TS) 23.247 V17.0.0, the contents of which are incorporated herein by reference.

In legacy user plane tunnel establishment, a tunnel may be created for a UE by transmitting UE context setup request/response messages between the tunnel endpoints (e.g. between a Distributed Unit and a corresponding Central Unit in case of F1 user plane or between the base station and a corresponding user plane function). These messages include UE specific information (e.g., UE FIAP ID/NGAP ID) which in turn uniquely associates the tunnel to a particular UE.

On the other hand, MBS employs shared tunnels for delivering user plane data (e.g. F1/NG user plane) to multiple UEs that have joined a particular service in order to benefit from a more efficient delivery of multicast/broadcast traffic. Thus, during session activation for MBS, a shared tunnel is established or if there is an already established shared tunnel for the given MBS, the tunnel is shared for the MBS session. When a UE joins an MBS service, an MBS session is established for that service on the user plane which is transmitted via the appropriate shared tunnel (using multicast). More specifically, traffic for the MBS service is transmitted using multicast, via the serving base station or a distributed unit thereof, over the shared user plane tunnel of that MBS service. Note that it is quite different to unicast which uses a dedicated user plane tunnel per UE.

The inventors have realised that the existing tunnel establishment procedures require UE specific information which are not compatible with the multicast transmission employed by MBS. Thus, it would be necessary to introduce a common tunnel establishment procedure for unicast and multicast use or to modify the legacy UE context setup procedure to support setting up of shared user plane tunnels between the respective endpoints.

The inventors have also realised that similar issues may arise during handover of UEs receiving MBS traffic which may require session modification (e.g. over the N4 interface) with respect to a shared user plane tunnel. For example, it may be necessary to add/modify a shared user plane tunnel in a new cell when a UE is being handed over to that cell. Similarly, when a shared user plane tunnel is not used by any UE due to handover (or when all UEs have left the corresponding MBS session), it may be beneficial to remove the MBS session relating to that tunnel at the serving user plane function (UPF). However, current session/tunnel management procedures are not suitable for such MBS related procedures.

### SUMMARY OF INVENTION

### Solution to Problem

Accordingly, the present invention seeks to provide methods and associated apparatus that address or at least alleviate (at least some of) the above-described issues.

In one aspect, the invention provides a method performed by a base station for providing Multicast and Broadcast Services (MBS), the method comprising: transmitting, to a network node, a message including first information identifying a tunnel associated with an MBS session, wherein the message indicates that the tunnel is a shared tunnel; and receiving, via the shared tunnel, user plane protocol data unit for the MBS session for transmitting to the UE, upon transmitting the message.

In one aspect, the invention provides a method performed by a base station for providing Multicast and Broadcast Services (MBS), the method comprising: receiving, from a network node, a request for setting up for a tunnel associated with an MBS session as a shared tunnel, the request including second information of the MBS session and first information identifying the tunnel; and receiving, via the shared tunnel, user plane protocol data unit for the MBS session for transmitting to the UE, upon receiving the message.

In one aspect, the invention provides a method performed by a network node for providing Multicast and Broadcast Services (MBS), the method comprising: receiving, from a base station, a message including first information identifying a tunnel associated with an MBS session, wherein the message indicates that the tunnel is a shared tunnel; and transmitting, via the shared tunnel, user plane protocol data unit for the MBS session to a user equipment (UE), upon receiving the message.

In one aspect, the invention provides a method performed by a network node the method comprising: transmitting, to a base station for providing Multicast and Broadcast Services (MBS), a request for setting up a tunnel associated with an MBS session as a shared tunnel, the request including second information of the MBS session and first information identifying the tunnel: wherein the shared tunnel is adapted to be used, by the base station, for transmitting user plane protocol data unit for the MBS session.

In one aspect, the invention provides a method performed by a first core network node for managing at least one Multicast and Broadcast Services (MBS) session provided using a shared tunnel, the method comprising: transmitting a session management message to a second core network node for managing a user plane associated with the at least one MBS session, the message including at least one of: information identifying one or more MBS session to be added at the second core network node: information identifying one or more MBS session to be modified at the second core network node; and information identifying one or more MBS session to be removed at the second core network node.

In one aspect, the invention provides a method performed by a second core network node for managing a user plane associated with at least one Multicast and Broadcast Services (MBS) session provided using a shared tunnel, the method comprising: receiving, from a first core network node, a session management message including at least one of: information identifying one or more MBS session to be added at the second core network node: information identifying one or more MBS session to be modified at the second core network node; and information identifying one or more MBS session to be removed at the second core network node.

In one aspect, the invention provides a base station for providing Multicast and Broadcast Services (MBS), comprising: means for transmitting, to a network node, a message including first information identifying a tunnel associated with an MBS session, wherein the message indicates that the tunnel is a shared tunnel; and means for receiving, via the shared tunnel, user plane protocol data unit for the MBS session for transmitting to the UE, upon transmitting the message.

In one aspect, the invention provides a base station for providing Multicast and Broadcast Services (MBS), the base station apparatus comprising: means for receiving, from a network node, a request for setting up a tunnel associated with an MBS session as a shared tunnel, the request including second information of the MBS session and first information identifying the tunnel; and means for receiving, via the shared tunnel, user plane protocol data unit for the MBS session for transmitting to the UE, upon receiving the message.

In one aspect, the invention provides a network node for providing Multicast and Broadcast Services (MBS), comprising: means for receiving, from a base station, a message including first information identifying a tunnel associated with an MBS session, wherein the message indicates that the tunnel is a shared tunnel; and means for transmitting, via the shared tunnel, user plane protocol data unit for the MBS session to a user equipment (UE), upon receiving the message.

In one aspect, the invention provides a network node comprising: means for transmitting, to a base station for providing Multicast and Broadcast Services (MBS), a request for setting up a tunnel associated with an MBS session as a shared tunnel, the request including second information of the MBS session and first information identifying the tunnel: wherein the shared tunnel is adapted to be used, by the base station, for transmitting user plane protocol data unit for the MBS session.

In one aspect, the invention provides a first core network node for managing at least one Multicast and Broadcast Services (MBS) session provided using a shared tunnel, the first core network node comprising: means for transmitting a session management message to a second core network node for managing a user plane associated with the at least one MBS session, the message including at least one of: information identifying one or more MBS session to be added at the second core network node: information identifying one or more MBS session to be modified at the second core network node; and information identifying one or more MBS session to be removed at the second core network node.

In one aspect, the invention provides a second core network node for managing a user plane associated with at least one Multicast and Broadcast Services (MBS) session provided using a shared tunnel, the second core network node comprising: means for receiving, from a first core network node, a session management message including at least one of: information identifying one or more MBS session to be added at the second core network node: information identifying one or more MBS session to be modified at the second core network node; and information identifying one or more MBS session to be removed at the second core network node.

### Advantageous Effects of Invention

Aspects of the invention extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied;

FIG. 2 illustrates schematically a mobile (cellular or wireless) telecommunication system to which embodiments of the invention may be applied;

FIG. 3 is a schematic block diagram of a mobile device forming part of the system shown in FIG. 1;

FIG. 4 is a schematic block diagrams of an access network node (e.g. base station) forming part of the system shown in FIG. 1;

FIG. 5 is a schematic block diagrams of an access network node (e.g. base station) forming part of the system shown in FIG. 1;

FIG. 6 is a schematic block diagram of a core network node forming part of the system shown in FIG. 1;

FIG. 7 is a schematic signalling (timing) diagrams illustrating some exemplary embodiments of the present invention;

FIG. 8 is a schematic signalling (timing) diagrams illustrating some exemplary embodiments of the present invention;

FIG. 9 is a schematic signalling (timing) diagrams illustrating some exemplary embodiments of the present invention;

FIG. 10 is a schematic signalling (timing) diagrams illustrating some exemplary embodiments of the present invention; and

FIG. 11 is a schematic signalling (timing) diagrams illustrating some exemplary embodiments of the present invention.

### DESCRIPTION OF EMBODIMENTS

### <Overview>

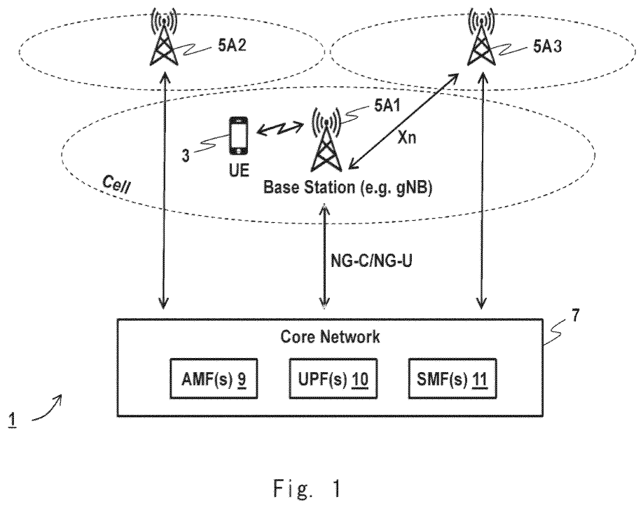

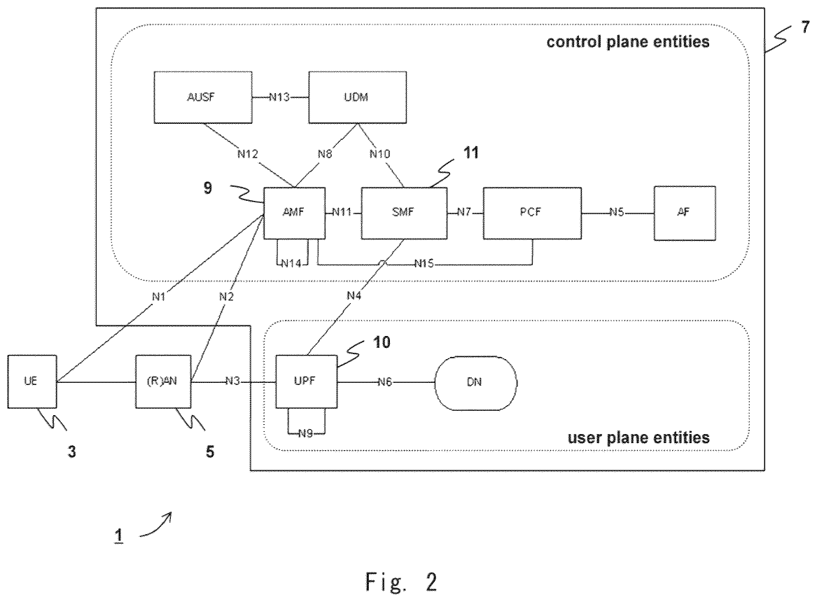

FIG. 1 and FIG. 2 illustrate schematically a mobile (cellular or wireless) telecommunication system 1 to which embodiments of the invention may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and three base stations 5A-5C are shown in FIG. 1 for illustration purposes, the system, when implemented, will typically include other base stations/(R) AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

It will be appreciated that the functionality of a gNB 5 (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units;

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the F1 interface connected with the gNB-DU.

gNB Distributed Unit (gNB-DU) 5D: a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP) 5C: a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

gNB-CU-User Plane (gNB-CU-UP) 5U: a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. In the example shown in FIG. 1, the core network 7 includes one or more AMF(s) 9, one or more UPF(s) 10, and one or more SMF(s) 11. It will be appreciated that the nodes or functions may have different names in different systems.

Further details of the core network 7 are shown in FIG. 2 which also shows the interfaces between respective network nodes. As can be seen, the core network 7 may typically include an Authentication Server Function (AUSF), a Unified Data Management (UDM) entity, a Policy Control Function (PCF), an Application Function (AF), amongst others. The core network 7 is coupled (via the UPF 10) to a Data Network (DN), such as the Internet or a similar Internet Protocol (IP) based network. The core network 7 may also be coupled to an Operations and Maintenance (OAM) function (not shown).

In this system 1, Multicast and Broadcast Services (MBS) functionality is provided to UEs 3 via their serving base station 5 and associated core network nodes such as the UPF 10 and the SMF 11. The UPF 10 may be an MBS specific UPF in which case it may be referred to as the MB-UPF 10M (e.g. dedicated to the provision of MBS functionality). Similarly, the SMF 11 may be an MBS specific SMF in which case it may be referred to as the MB-SMF 11M. However, it will be appreciated that any suitable UPF 10/SMF 11 may be used for MBS.

MBS traffic is distributed over shared user plane tunnels, when appropriate. Specifically, MBS user plane data (e.g. F1-U/NG-U data) for a given service is delivered over an associated shared tunnel, using multicast transmission, to those UEs that have joined that particular service.

When the first UE joins an MBS service, an MBS session is established for that service on the user plane between the core network 7 and the UE's serving base station 5 (and between units of a distributed gNB handling the user plane, if applicable). For any UE (at least one UE) interested in that MBS service, the MBS traffic can be transmitted via multicast, via a given serving base station or a distributed unit thereof, using the shared user plane tunnel.

In order to realise sharing of the user plane tunnel(s) among UEs 3, the nodes of this network (e.g. the base station 5 and the AMF 9) are configured to use an appropriate indicator to indicate when a tunnel is a shared tunnel. For example, this indicator may be used when the tunnel is associated with the UE 3 (e.g. the tunnel being set up or modified for an MBS that the UE 3 has joined). The Transport Network Layer (TNL) address of the shared tunnel is used as the Transport Layer Information in F1-U/NG-U session management signalling when the UE 3 joins the MBS service.

Specifically, when an MBS session is requested for a UE 3, the base station 5 that is used as the endpoint of the NG-U transport bearer of that MBS session (and/or the gNB-DU endpoint of the F1 transport bearer) is used as the user plane TNL address for the UE 3 for the delivery of MBS traffic (downlink Protocol Data Units). The signalling messages exchanged with the tunnel endpoints include the indicator (a field or a flag) that the tunnel is a shared tunnel (as opposed to a tunnel that is to be used by a single UE only). Effectively, this option re-uses existing (legacy) UE context setup (modification) request and response messages to setup a shared F1-U/NG-U tunnel, by including an appropriate shared tunnel indicator in the response (when configuring the TNL address for the session).

Upon receiving a request from the first UE 3 that is interested in the MBS session, the AMF 9 requests (the Central Unit of) the base station 5 to set up (or modify) the UE context so that the associated F1-U/NG-U tunnel is configured as a shared tunnel. When the shared tunnel indicator is present, the base station 5 (DU) is aware that the tunnel is a shared tunnel which can be shared by subsequent UEs, and the base station 5 (or DU) also indicates that a shared tunnel is used in its response to the AMF 9 (or the CU).

Alternatively, instead of an explicit indicator, or in addition to it, an appropriate (non-UE associated) FIAP/NGAP message may be used to setup a shared tunnel for the MBS. For example, the central unit of the base station 5 may be configured to send an appropriate FIAP signalling message (e.g. a ‘Shared F1-U GTP tunnel setup request’ message and/or the like) to the distributed unit for setting up a shared tunnel for a UE 3. Similarly, the AMF 9 may be configured to send an appropriate NGAP signalling message (e.g. a ‘Shared NG-U GTP tunnel setup request’ message and/or the like) to the serving base station 5 for setting up a shared tunnel for the UE 3. In this case, the message itself acts as the shared tunnel indicator (although an explicit indicator/flag may be included in the message if appropriate).

In any case, it will be appreciated that the messages used for configuring the MBS session do not include UE specific information (e.g., UE F1AP ID/NGAP ID) which uniquely associates the tunnel to a particular UE 3 (although such UE specific information, e.g. UE ID may be included for other purposes). Even if such information is included, the shared tunnel indicator informs the base station that the tunnel can be shared among UEs 3.

To support handover of UEs 3 receiving MBS over shared tunnels, session management messages exchanged (over the N4 interface) between the SMF 11 and the UPF 10 are adapted to include the relevant MBS session parameters. For example, when performing handover related signalling for a UE 3, the SMF 11 may provide one or more of the following parameters to the UPF 10 (together with an associated N4 Session ID):
MBS session to add/modify list (the SMF 11 includes any newly added MBS session in case there is no ongoing MBS session in the target base station) which may include one or more of the following (per MBS session): MBS context; Quality of Service (QOS) flows: MBS session ID: Temporary Mobile Group Identity (TMGI): UE identifier (UE ID): UL NG-U UP TNL Information; and DL QoS Flow per TNL Information; and
MBS session to remove list (to remove a particular MBS session in case the last UE 3 has left that MBS session, not limited to UE mobility scenario): MBS session ID(s) for each MBS session to be removed.

Beneficially, using at least some of the above parameters the UPF 10 is able to keep track of which UE 3 uses which MBS session(s) and maintain the MBS session(s) for the UE 3 even after handover, using the correct shared tunnel(s). This approach may be particularly useful in case of Xn based handover from an MBS supporting NG-RAN node (base station 5) to another NG-RAN node (currently specified in clause 7.2.3.2 of 3GPP TS 23.247).

### <User Equipment (UE)>

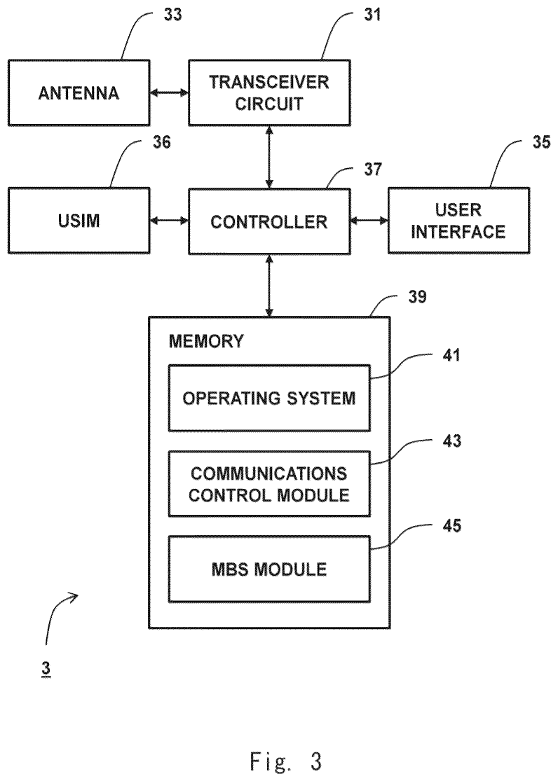

FIG. 3 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43 and an MBS module 45.

The communications control module 43 is responsible for handling (generating/sending/receiving) signalling messages and uplink/downlink data packets between the UE 3 and other nodes, including (R) AN nodes 5 and core network nodes. The signalling may comprise RRC signalling (to/from the (R) AN nodes 5) and/or NG-C/NG-U signalling (to/from the core network 7).

The MBS module 45 is responsible for handling signalling relating to multimedia broadcast services.

### <Access Network Node (Base Station)>

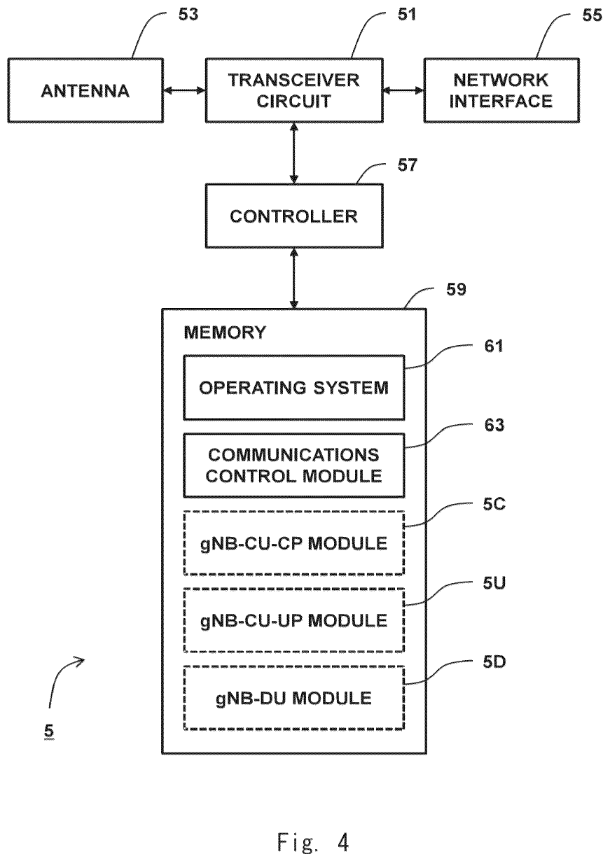

FIG. 4 is a block diagram illustrating the main components of a base station 5 (or a similar access network node) shown in FIG. 1. As shown, the base station 5 has a transceiver circuit 51 for transmitting signals to and for receiving signals from user equipment (such as the mobile device 3) via one or more antenna 53, a network interface 55 for transmitting signals to and for receiving signals from the core network 7 and neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 4, the network interface 55 will also typically include a base station to base station interface portion (e.g. Xn and/or the like), and a core network interface portion (e.g. NG-C/NG-U/N2/N3).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. Non-Access Stratum, Radio Resource Control, system information, paging, and/or the like). It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

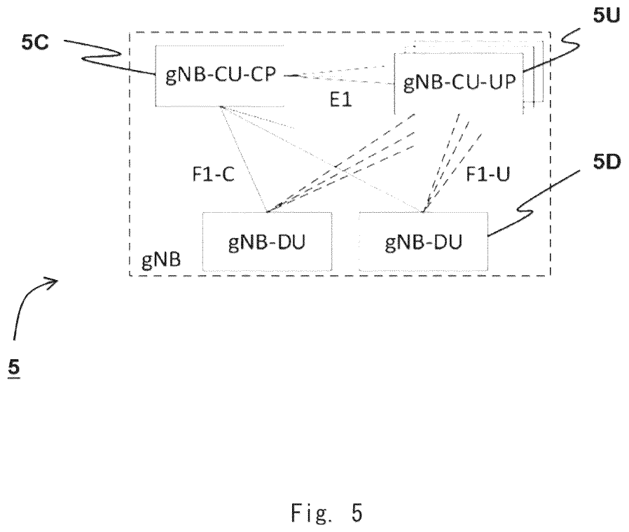

As shown in FIG. 5, when the base station 5 comprises a distributed gNB or en-gNB, the network interface 55 also includes an E1 interface and an F1 interface (F1-C for control plane and F1-U for user plane) to communicate signals between respective functions of the distributed gNB or en-gNB. In this case, the software also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed gNB or en-gNB. If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed gNB or en-gNB.

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### <Core Network Node>

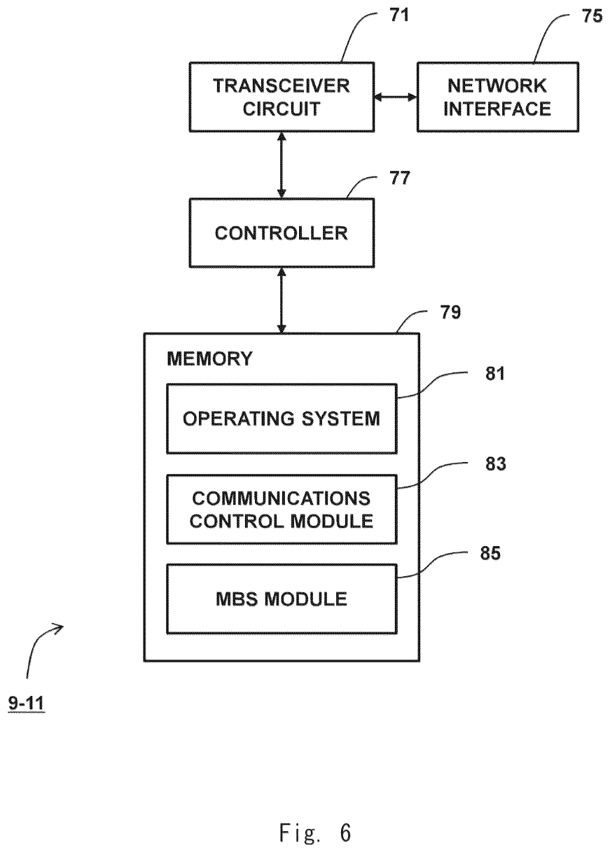

FIG. 6 is a block diagram illustrating the main components of a core network node shown in FIG. 1 (e.g. the AMF 9, the UPF 10, or the SMF 11). As shown, the core network node includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the base station 5 or other (R) AN nodes, as appropriate. The network interface 75 typically includes an appropriate base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an MBS module 85 (optional).

The communications control module 83 is responsible for handling (generating/sending/receiving) signalling between the core network node and other nodes, such as the UE 3, (R) AN nodes, and other core network nodes.

If present, e.g. in an MB-SMF or MB-UPF, the MBS module 85 is responsible for handling signalling relating to multimedia broadcast services (control signalling and/or MBS traffic). The signalling may comprise signalling relating to MBS sessions and shared tunnel management and associated parameters.

### DETAILED DESCRIPTION

The following is a description of some exemplary procedures performed by the nodes of the system shown in FIG. 1 to support MBS sessions over shared tunnels.

### <Option 1—F1-U/NG-U Session Management>

As can be seen in FIG. 1 and FIG. 2, the NG-U (NG user plane) protocol is used between the UE 3 and the core network (UPF 10), carried over the N3 interface between the base station 5 and the core network 7. When a distributed base station 5 is involved, the F1-U (F1 user plane) protocol is used between the central unit 5C of the distributed base station 5 and the distributed unit 5D responsible for the MBS user plane.

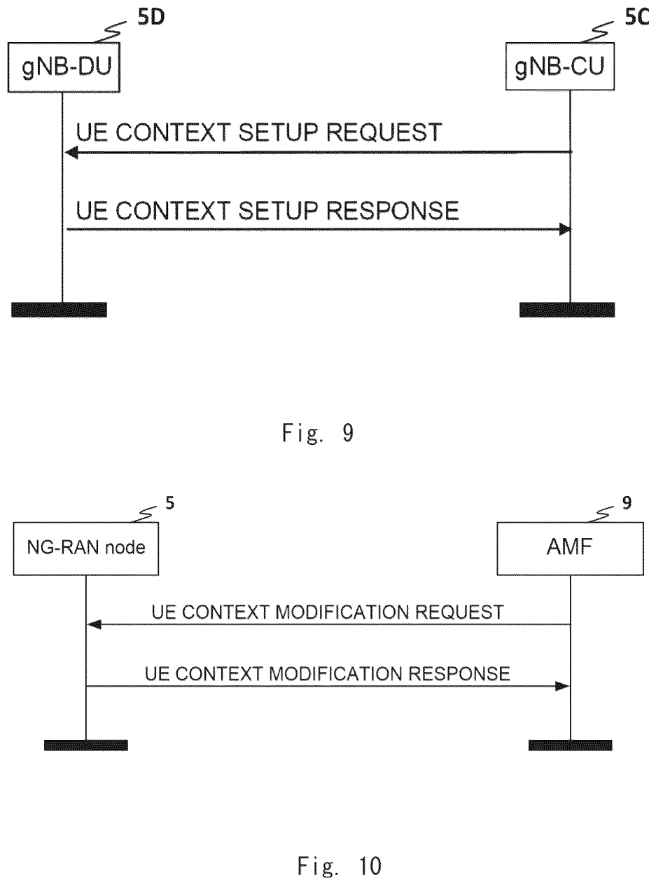

The F1 Application Protocol (F1AP) is specified in 3GPP TS 38.473 V16.7.0, and the NG Application Protocol (NGAP) is specified in 3GPP TS 38.413 V16.7.0. In the present example, the UE context setup procedure is adapted to associate a shared user plane tunnel (F1-U shared tunnel and/or NG-U shared tunnel) to a particular MBS session (and any UE for which the corresponding MBS traffic is intended). In particular, one or more of the following FIAP/NGAP messages may be used for this purpose: UE Context Setup Request: UE Context Setup Response; UE Context Modification Request; and UE Context Modification Response (see FIG. 9 and FIG. 10).

In case of an NG-U shared tunnel, the NG-RAN node 5 (e.g. base station/gNB) and the UPF 11 are the tunnel endpoints. In this case, when a shared tunnel has been set up for an MBS session, an appropriate NGAP message (e.g. UE Context Modification Response) may be sent by the base station 5 to the AMF 9 to confirm the modification of a UE context for MBS (upon the UE 3 joining the MBS).

In case of an F1-U shared tunnel (or the F1 portion of an NG-U shared tunnel), the gNB-DU 5D and the gNB-CU 5U are the tunnel endpoints. The F1-U shared tunnel may be associated with a particular UE 3 by modifying the associated UE context for receiving MBS traffic using multicast. For example, when such a shared tunnel has been set up for an MBS session (upon the UE 3 joining the MBS), an appropriate FIAP message (e.g. UE Context Setup Response) may be sent by the gNB-DU 5D to the gNB-CU 5U to confirm the modification of a UE context.

The TNL address of the shared tunnel is used as the Transport Layer Information (Tunnel Endpoint Identifier or ‘TEID’) in associated F1-U/NG-U session management signalling for UEs 3 joining (or leaving) the MBS session. The TNL address for the session is configured with a shared tunnel indicator. The TEID associated with the base station 5 that is used as the endpoint of the NG-U transport bearer (and/or the gNB-DU endpoint of the F1 transport bearer) may be used as the Transport Layer Information for any UE 3 joining the same MBS session. Thus, downlink protocol data units (PDUs) that belong to the corresponding MBS traffic are delivered to the correct user plane TNL address (for transmission to the UE(s) 3) using multicast.

For any other UE 3 joining the same MBS session after the first UE 3 has established a shared F1-U/NG-U tunnel, the UE context setup (or modification) requests only need to reference the previously established F1-U/NG-U tunnel for the given MBS traffic (e.g. by indicating the user plane TNL address for the tunnel endpoint and/or any other suitable information associated with the tunnel endpoint).

The TEID of the shared tunnel is included in context setup (modification) request signalling for other UEs 3 joining the same MBS session. Upon reception of the tunnel TEID already used for a shared tunnel, the base station 5 (distributed unit) knows that this is a shared NG-U (F1-U) tunnel.

### <Option 2—Non-UE Associated FIAP/NGAP Messages>

In this example, non-UE associated F1AP/NGAP messages are used to setup a shared F1-U/NG-U tunnel for an MBS session. Such non-UE associated messages may be used instead of an explicit indicator (as in option 1), or in addition to it.

For example, a ‘Shared tunnel setup request’ FIAP message (alternatively, a ‘Shared F1-U GTP tunnel setup request’ message and/or the like) may be used by the central unit of the base station 5 to request the distributed unit to set up a shared F1 user plane tunnel for a UE 3 (for a particular MBS session). Similarly, a ‘Shared tunnel setup request’ NGAP message (alternatively, a ‘Shared NG-U GTP tunnel setup request’ message and/or the like) may be used by the AMF 9 to request the serving base station 5 to set up a shared NG-U tunnel for the UE 3. It will be appreciated when one of these messages is used it is not necessary to include an explicit shared tunnel indicator information element or flag since the message itself acts as the shared tunnel indicator.

### <Messages and Information Elements>

Further details of the FIAP/NGAP messages and some exemplary information elements are shown below (for both options 1 and 2). It will be appreciated that other suitable messages and information elements may be used, if appropriate, to convey information indicating (or identifying) a shared tunnel allocated to one or more MBS session.

F1AP UE Context Setup Response/UE Context Modification Response (based on 3GPP TS 38.473)

This message is used to confirm successful setup/modification of a UE context (upon a UE 3 joining an MBS session).

Direction: gNB-DU 5D to gNB-CU 5U

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU UE F1AP ID | M | | 9.3.1.4 | | YES | reject |
| gNB-DU UE F1AP ID | M | | 9.3.1.6 | | YES | reject |
| DU To CU RRC | O | | 9.3.1.26 | | YES | reject |
| Information | | | | | | |
| DRB Setup List | | 0 . . . 1 | | List of successfully | YES | ignore |
| | | | | established DRBS. | | |
| >DRB Setup Item IEs | | 1 . . . | | | EACH | ignore |
| | | <maxnoofDRBs> | | | | |
| >>DRB ID | M | | 9.3.1.8 | | — | |
| >>LCID | O | | 9.3.1.35 | LCID for the | — | |
| | | | | primary path or for | | |
| | | | | the split secondary | | |
| | | | | path for fallback to | | |
| | | | | split bearer if | | |
| | | | | PDCP duplication | | |
| | | | | is applied. | | |
| >>DL UP TNL | | 1 | | | — | |
| Information to be | | | | | | |
| setup List | | | | | | |
| >>>DL UP TNL | | 1 . . . | | | — | |
| Information to Be | | <maxnoofDLUPTNLInformation> | | | | |
| Setup Item IEs | | | | | | |
| >>>>DL UP TNL | M | | UP | (Shared) gNB-DU | — | |
| Information (with | | | Transport | endpoint of the F1 | | |
| shared tunnel | | | Layer | transport bearer. | | |
| indicator, if | | | Information | For delivery of DL | | |
| appropriate) | | | 9.3.2.1 | MBS PDUS. | | |

As shown in the last row above, the ‘DL UP TNL Information’ information element includes appropriate user plane (UP) Transport Layer Information (TNL address) for a given MBS session. Effectively, this information identifies the gNB-DU endpoint of the F1 transport bearer to be used for delivery of MBS traffic over a shared user plane tunnel.

Initial Context Setup Response (based on 3GPP TS 38.413) This message is sent by the NG-RAN node (base station 5) to the AMF 9 to confirm the setup of a UE context for an MBS session.

Direction: NG-RAN node 5 to AMF 9

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | ignore |
| RAN UE NGAP ID | M | | 9.3.3.2 | | YES | ignore |
| PDU Session | | 0 . . . 1 | | | YES | ignore |
| Resource Setup | | | | | | |
| Response List | | | | | | |
| >PDU Session | | 1 . . . | | | — | |
| Resource Setup | | <maxnoofPDUSessions> | | | | |
| Response Item | | | | | | |
| >>PDU Session ID | M | | 9.3.1.50 | | — | |
| >>PDU Session | M | | OCTET | Containing the | — | |
| Resource Setup | | | STRING | PDU Session | | |
| Response Transfer | | | | Resource Setup | | |
| | | | | Response Transfer | | |
| | | | | IE specified in | | |
| | | | | subclause 9.3.4.2 | | |
| | | | | or the UP | | |
| | | | | Transport Layer | | |
| | | | | Information IE | | |
| | | | | specified in | | |
| | | | | subclause 9.3.2.2. | | |

In this case, when a shared tunnel is set up, the ‘PDU Session Resource Setup Response Transfer’ information element includes appropriate user plane (UP) Transport Layer Information (TNL address) for the given MBS session at the base station 5. Effectively, this information element identifies the endpoint of the NG-U transport bearer (at the base station 5) to be used for delivery of MBS traffic over a shared user plane tunnel and includes an indicator that this is a shared tunnel (see details below). It will be appreciated that when the ‘shared tunnel’ is set up for the first UE, it is effectively a UE specific tunnel (until the tunnel is associated with other UEs, in subsequent Initial Context Setup procedures).

UP Transport Layer Information (based on 3GPP TS 38.473, clause 9.3.2.1) This information element identifies an F1 transport bearer associated to a Data Radio Bearer (DRB). It contains a Transport Layer Address and a Tunnel Endpoint Identifier. The Transport Layer Address is an IP address to be used for the F1 user plane transport. The Tunnel Endpoint Identifier is to be used for the user plane transport between the gNB-CU 5C and the gNB-DU 5D.

| | | | IE type | |
|---|---|---|---|---|
| IE/ | | | and | Semantics |
| Group Name | Presence | Range | reference | description |
| CHOICE | M | | | |
| Transport | | | | |
| Layer | | | | |
| Information | | | | |
| >GTP Tunnel | | | | |
| >>Transport | M | | 9.3.2.3 | |
| Layer Address | | | | |
| >>GTP-TEID | M | | 9.3.2.2 | |
| >>Shared | O | ENUMERATED | | |
| tunnel | | (true, false, . . .) | | |
| indicator | | | | |

In this example, the ‘UP Transport Layer Information’ information element includes an appropriate indication (‘Shared tunnel indicator’ field) to indicate that the corresponding tunnel is a shared tunnel. It will be appreciated that any other suitable indication or information element or field may be used, e.g. ‘MBS tunnel’, ‘multicast tunnel’, ‘tunnel type: MBS’, ‘tunnel type: shared’, ‘tunnel type: multicast’, and/or the like.

P Transport Layer Information (based on 3GPP TS 38.413, clause 9.3.2.2) This information element is used to provide the NG user plane (NG-U) transport layer information associated with a PDU session (in this case an MBS session) for an NG-RAN node-UPF pair. It corresponds to an IP address and a Tunnel Endpoint Identifier.

| | | | IE type | |
|---|---|---|---|---|
| IE/ | | | and | Semantics |
| Group Name | Presence | Range | reference | description |
| CHOICE UP | M | | | |
| Transport | | | | |
| Layer | | | | |
| Information | | | | |
| >GTP tunnel | | | | |
| >>Endpoint IP | M | | Transport | |
| Address | | | Layer | |
| | | | Address | |
| | | | 9.3.2.4 | |
| >>GTP-TEID | M | | 9.3.2.5 | |
| >>Shared | O | ENUMERATED | | |
| tunnel | | (true, false, . . .) | | |
| indicator | | | | |

In this example, the ‘UP Transport Layer Information’ information element includes an appropriate indication (‘Shared tunnel indicator’ field) to indicate that the corresponding tunnel is a shared tunnel. It will be appreciated that any other suitable indication or information element or field may be used, e.g. ‘MBS tunnel’, ‘multicast tunnel’, ‘tunnel type: MBS’, ‘tunnel type: shared’, ‘tunnel type: multicast’, and/or the like.

### Shared Tunnel Setup Request (F1AP)

This message is sent by the central unit of the NG-RAN node (base station 5) to the distributed unit to request a shared tunnel for an MBS session that the UE 3 intends to join. The message, which may be referred to as a ‘Shared F1-U GTP tunnel setup request’ includes the following information: an identifier of the central unit (e.g. a ‘gNB-CU shared F1AP ID’); an identifier of the distributed unit (e.g. a ‘gNB-DU shared F1AP ID’), a multicast radio bearer identifier (‘MRB ID’), and an MBS session ID (e.g. TMGI). It will be appreciated that the message may also include a shared tunnel indicator (e.g. in an ‘UP Transport Layer Information’ information element or similar) although such indication may be redundant since the identifiers of the distributed unit and the central unit already indicate that this particular tunnel is not a UE specific tunnel.

Direction: gNB-CU 5C to gNB-DU 5D

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU shared | M | | 9.3.1.4 | | YES | reject |
| F1AP ID | | | | | | |
| gNB-DU shared | O | | 9.3.1.5 | | YES | ignore |
| F1AP ID | | | | | | |
| MRB to Be Setup List | | 0 . . . 1 | | | YES | reject |
| >MRB to BE Setup | | 1 . . . | | | EACH | ignore |
| Item IEs | | <maxnoofDRBs> | | | | |
| >>MRB ID | M | | 9.3.1.8 | | — | |
| >>MBS session | | | | | | |
| ID(TMGI) | | | | | | |
| >>CHOICE QoS | M | | | | — | |
| Information | | | | | | |
| >>>MRB | | 1 | | Shall be used for | YES | ignore |
| Information | | | | NG-RAN cases | | |
| >>>>MRB QoS | M | | 9.3.1.45 | | — | |
| >>>>S-NSSAI | M | | 9.3.1.38 | | — | |
| >>>>Notification | O | | 9.3.1.56 | | | |
| Control | | | | | | |
| >>>>Flows | | 1 . . . | | | — | |
| Mapped to MRB | | <maxnoofQoSFlows> | | | | |
| Item | | | | | | |
| >> UL UP TNL | | 1 | | | — | |
| Information to be | | | | | | |
| setup List | | | | | | |
| >>> UL UP TNL | | 1 . . . | | | — | |
| Information to Be | | <maxnoofULUPTNLInformation> | | | | |
| Setup Item IEs | | | | | | |
| >>>>UL UP TNL | M | | UP Transport | gNB-CU endpoint | — | |
| Information | | | Layer | of the F1 transport | | |
| | | | Information | bearer. For | | |
| | | | 9.3.2.1 | delivery of UL | | |
| | | | | PDUS. | | |

In this example, the Shared tunnel setup request message uses identifiers of the distributed unit and the central unit (e.g. ‘gNB-CU shared F1AP ID’ and ‘gNB-DU shared F1AP ID’) instead of UE specific identifiers as in case of a UE specific tunnel (e.g. ‘gNB-CU UE F1AP ID’ and ‘gNB-DU UE F1AP ID’, respectively). This allows reusing the same tunnel for other UEs to deliver MBS traffic via multicast.

Shared tunnel setup request (NGAP)

This message is sent by the AMF 9 to the serving base station 5 to request a shared tunnel for an MBS session that the UE 3 intends to join. The message, which may be referred to as a ‘Shared NG-U GTP tunnel setup request’ includes the following information: an identifier of the AMF 9 (e.g. a ‘AMF Shared NGAP ID’); an identifier of the base station 5 (e.g. a ‘RAN Shared NGAP ID’), and an MBS session ID (e.g. TMGI). It will be appreciated that the message may also include a shared tunnel indicator (e.g. in an ‘UP Transport Layer Information’ information element or similar) although such indication may be redundant since the identifiers of the distributed unit and the central unit already indicate that this particular tunnel is not a UE specific tunnel.

Direction: AMF 9 to gNB 5

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF Shared NGAP | M | | 9.3.3.1 | | YES | reject |
| ID | | | | | | |
| RAN Shared NGAP | M | | 9.3.3.2 | | YES | reject |
| ID | | | | | | |
| PDU Session | | 0 . . . 1 | | | YES | reject |
| Resource Setup | | | | | | |
| Request List | | | | | | |
| > PDU Session | | 1 . . . | | | — | |
| Resource Setup | | <maxnoofPDUSessions> | | | | |
| Request Item | | | | | | |
| >>PDU Session ID | M | | 9.3.1.50 | | — | |
| >>MBS session | | | | | | |
| ID(TMGI) | | | | | | |
| >> PDU Session | O | | NAS-PDU | | — | |
| NAS-PDU | | | 9.3.3.4 | | | |
| >> S-NSSAI | M | | 9.3.1.24 | | — | |
| >>PDU Session | M | | OCTET | Containing the | — | |
| Resource Setup | | | STRING | PDU Session | | |
| Request Transfer | | | | Resource Setup | | |
| | | | | Request Transfer | | |
| | | | | IE specified in | | |
| | | | | subclause 9.3.4.1. | | |
| >>PDU Session | O | | Expected UE | Expected UE | YES | ignore |
| Expected UE | | | Activity | Activity Behaviour | | |
| Activity Behaviour | | | Behaviour | for the PDU | | |
| | | | 9.3.1.94 | Session. | | |

After the shared F1-U/NG-U tunnel has been established for the first UE 3, any other UE 3 joining the same MBS session can be configured to use the pre-established shared tunnel. This may be achieved by including the identifier of the shared tunnel (TEID) in the MRB configuration part of the UE context setup/modification message or the Initial UE context setup/modification message. Upon reception of the TEID of the shared tunnel, the distributed unit/base station knows that the MBS session will be provided via a shared F1-U/NG-U tunnel.

### <Timing Diagrams>

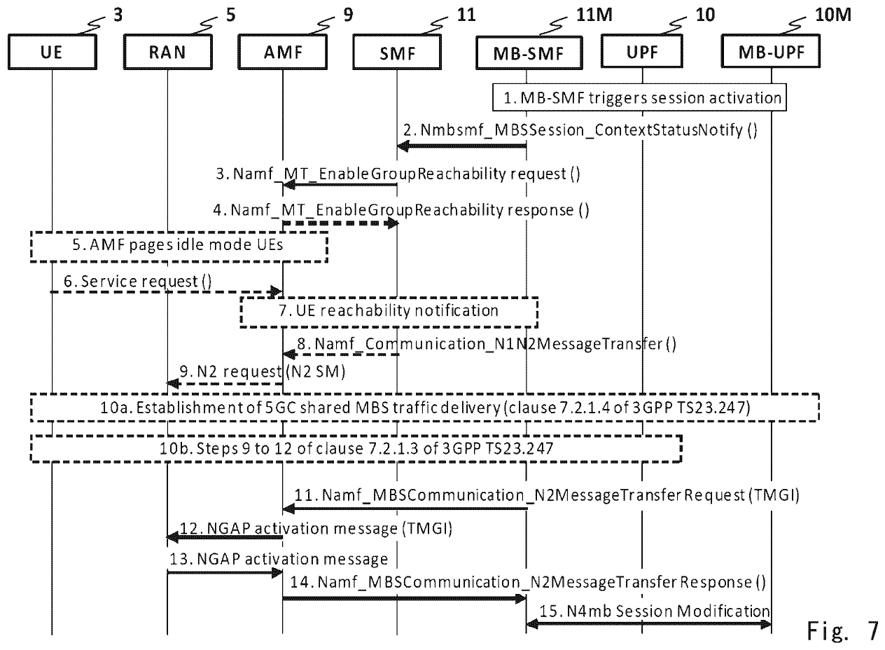

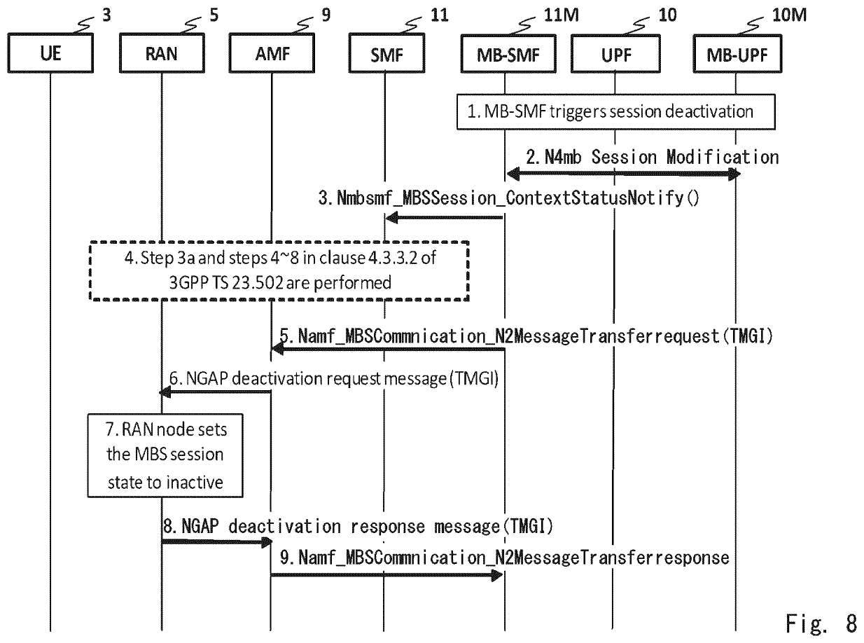

The following is a description of the relevant steps of a procedure for establishing a shared tunnel for a UE 3 for receiving MBS traffic (FIG. 7) and a procedure for deactivating a shared tunnel (FIG. 8), using the signalling messages and information elements described above. It will be appreciated that the procedure illustrated in FIG. 7 (or a similar procedure) may also be used for associating an already established shared tunnel to the UE 3 and/or to any further UEs 3, if appropriate.

The current procedures for MBS session activation and MBS session deactivation are illustrated in FIGS. 7.2.5.2-1 and 7.2.5.3-1 of 3GPP TS 23.247, respectively. FIG. 7 is based on FIG. 7.2.5.2-1 (MBS session activation procedure) but the messages have been adapted to support shared tunnels. Note: In this procedure, steps 2 to 10 and steps 11 to 14 can be executed in parallel.

As shown in step 1, session activation is triggered by an MBS specific SMF (denoted ‘MB-SMF 11M’). For example, session activation may be triggered upon an application function (AF) requesting the MB-SMF 11M to activate an MBS session for a UE 3 or a user plane function (UPF) receiving multicast data for the UE 3 and notifying the MB-SMF 11M.

The SMF 11 determines which connected mode UEs 3 have joined the MBS session and contacts the AMF 9 of these UEs 3 (see step 8).

If there is no shared tunnel for the given MBS session via the base station 5 serving a UE 3, then a new shared tunnel is set up for the MBS session in steps 10a. Effectively, step 10a is a procedure for establishment of shared delivery toward the NG-RAN node. This procedure is based on clause 7.2.1.4 of 3GPP TS23.247 but the messages have been adapted to use the shared tunnel endpoints as described above with reference to option 1 or option 2.

If there is a shared tunnel for the MBS session but the UE 3 does not use this tunnel, then, in step 10b, a PDU Session modification procedure is performed for the UE 3 to join the multicast session via the shared tunnel. This procedure is based on steps 9 to 12 of clause 7.2.1.3 of 3GPP TS23.247. However, the steps have been adapted to use the shared tunnel endpoints as described above with reference to option 1 or option 2.

Once a new shared tunnel has been established for the UE 3 or the UE 3 has been configured to join an existing shared tunnel, then the steps 11 to 15 are performed.

FIG. 8 is based on FIG. 7.2.5.3-1 of 3GPP TS 23.247 (MBS session deactivation procedure). In this case, however, the messages have been adapted to use the shared tunnel endpoints described above with reference to option 1 or option 2.

Beneficially, using these procedures, the nodes involved with the user plane (i.e. the UE, the base station 5 (CU/DU), and the UPF 10) can use an appropriate shared tunnel for multicast delivery of MBS traffic and remove any shared tunnel that is no longer required.

N4 Session Management (e.g. Handover/UE Mobility)

Clause 5.8.2.11 of 3GPP TS 23.501 describes the parameters used for N4 session management. The following is a description of some MBS session parameters that may be used in N4 session management to support the provision of MBS over shared tunnels.

Session management messages are exchanged between the SMF 11 and the UPF 10 over the N4 interface. In this system, the N4 interface messages are adapted to include the relevant MBS session parameters as well. For example, when performing handover related signalling for a UE 3, the SMF 11 may provide one or more of the following parameters to the UPF 10 (together with an associated N4 Session ID):
MBS session to add/modify list (the SMF 11 includes any newly added MBS session in case there is no ongoing MBS session in the target base station) which may include one or more of the following (per MBS session): MBS context; Quality of Service (QOS) flows: MBS session ID: Temporary Mobile Group Identity (TMGI): UE identifier (UE ID): UL NG-U UP TNL Information; and DL QoS Flow per TNL Information; and
MBS session to remove list (to remove a particular MBS session in case the last UE 3 has left that MBS session): MBS session ID(s) for each MBS session to be removed.

Effectively, the MBS session to add/modify list information element includes information identifying any MBS session to be added or modified at the UPF 10, and the MBS session to remove list information element includes information identifying any MBS session to be removed at the UPF 10. It will be appreciated that the provision of information identifying one or more MBS session to be removed is not limited to UE mobility and this information may be provided to the UPF 10 whenever there is an MBS shared tunnel that is no longer used by any UE (e.g. when all UEs have left the corresponding MBS session).

Beneficially, using at least some of the above parameters the UPF 10 is able to keep track of which UE 3 uses which MBS session(s) and maintain the MBS session(s) for the UE 3 even after handover, using the correct shared tunnel(s). This approach may be particularly useful in case of Xn based handover from an MBS supporting NG-RAN node (base station 5) to another NG-RAN node.

FIG. 9 illustrates schematically the (F1AP) UE context setup procedure, including the ‘UE Context Setup Request’ and ‘UE Context Setup Response’ messages which may be adapted to include information identifying the shared tunnel and/or a shared tunnel indicator.

FIG. 10 illustrates schematically the (NGAP) UE context modification procedure, including the ‘UE Context Modification Request’ and ‘UE Context Modification Response’ messages which may be adapted to include information identifying the shared tunnel and/or a shared tunnel indicator.

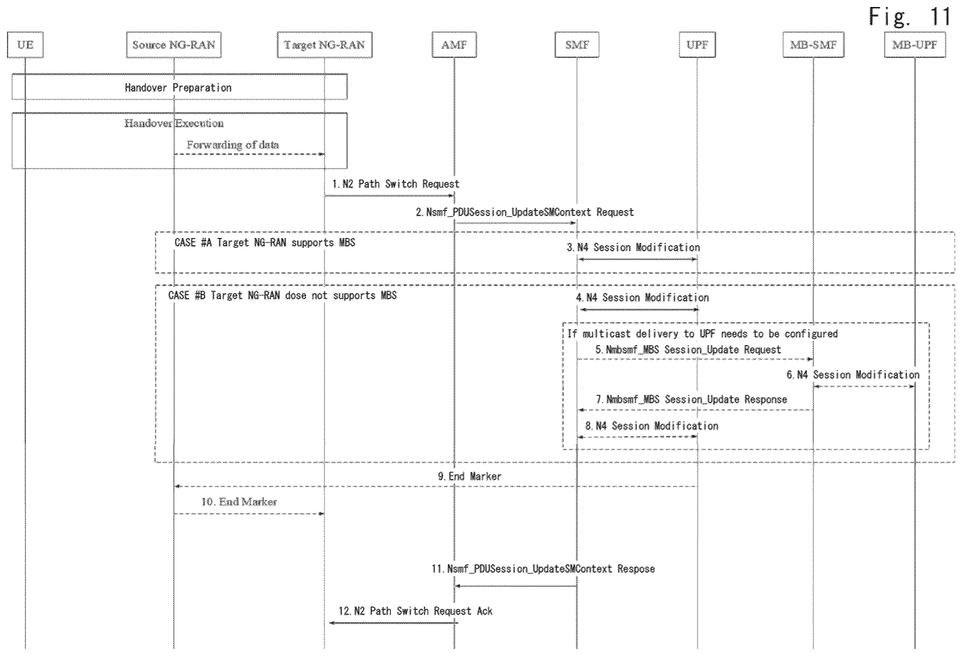

FIG. 11 illustrates schematically the details of an exemplary Xn based handover procedure. FIG. 11 is signalling (timing) diagram based on FIG. 7.2.3.2-1 of 3GPP TS 23.247. However, in this case, the ‘N4 Session Modification’ messages (e.g. in steps 3, 4, 6, or 8) are adapted to include information identifying any MBS session to be added, modified, or removed by the UPF 10 (e.g. the MBS session to add/modify list and/or MBS session to remove list information elements described above).

For sake of completeness, it will be appreciated that the SMF 11 may also provide one or more of the following parameters to the UPF 10:
Packet Detection Rules (PDR) that contain information to classify traffic (PDU(s)) arriving at the UPF 10;
Forwarding Action Rules (FAR) that contain information on whether forwarding, dropping or buffering is to be applied to a traffic identified by PDR(s);
Multi-Access Rules (MAR) that contain information on how to handle traffic steering, switching and splitting for a MA PDU Session;
Usage Reporting Rules (URR) contains information that defines how traffic identified by PDR(s) shall be accounted as well as how a certain measurement shall be reported;
QoS Enforcement Rules (QER), that contain information related to QoS enforcement of traffic identified by PDR(s);
Session Reporting Rules (SRR) that contain information to request the UP function to detect and report events for a PDU session that are not related to specific PDRs of the PDU session or that are not related to traffic usage measurement.
Trace Requirements;
Port Management Information Container in 5GS; and
Bridge Information.

### <Modifications and Alternatives>

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the above described shared tunnel may be provided using the GPRS Tunnelling Protocol (GTP). Thus, the tunnel may also be referred to as a (shared) GTP tunnel or a GTP user plane (GTP-U) tunnel. Although the term ‘shared tunnel’ is used in this description for sake of illustrating the inventive concept, it will be appreciated that a tunnel may be used by a single UE only, in which case it is not shared by other UE (e.g. initially). However, regardless of the number of UEs using a tunnel, by using an appropriate shared tunnel indicator, an MBS tunnel indicator, and/or the like, it is possible to adapt a user plane tunnel for sharing among a plurality of UEs.

In the above description, the FIAP interface and associated messages were used as examples to illustrate the operation of the invention between units of a distributed base station apparatus. However, it will be appreciated that any other suitable interface or messages may be used. Similarly, the NGAP interface and associated messages were used as examples to illustrate the operation of the invention between a node (e.g. a base station apparatus) of an access network (or RAN) and a node of a core network. However, it will be appreciated that any other access network to core network interface or access network to core network messages may be used. It will be appreciated that in other releases the same interfaces and/or messages may have different names than the ones described in the above example.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP TS 38.300 V16.7.0 and 3GPP TS 37.340 V16.7.0 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above embodiments may be applied to 5G New Radio and LTE systems (E-UTRAN), and any future generation systems. A base station that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

In the above description, the UE, the access network node, and the data network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors: microprocessors: central processing units (CPUs): arithmetic logic units (ALUs): input/output (IO) circuits; internal memories/caches (program and/or data): processing registers: communication buses (e.g. control, data and/or address buses); direct memory access (DMA) functions: hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node, and the data network node as a signal over a computer network, or on a recording medium. Further, the functionality performed by part or all of this software may be performed using one or more dedicated hardware circuits. However, the use of software modules is preferred as it facilitates the updating of the UE, the access network node, and the data network node in order to update their functionalities.

The above embodiments are also applicable to ‘non-mobile’ or generally stationary user equipment.

The message may comprise a base station to core network protocol message or a base station distributed unit to central unit protocol message.

The message may include a response to a message requesting setting up of the associated UE context for the UE (e.g. a UE Context Setup Response or a Shared F1-U GTP Tunnel Setup Response) or a response to a message requesting UE context modification (e.g. a UE Context Modification Response or a Shared F1-U GTP Tunnel Modification Response).

The method performed by the base station apparatus may further comprise receiving, from the network node, a request including the information (e.g. a UE Context Setup Request or a UE Context Modification Request).

The request may comprise at least one of: a ‘Shared Tunnel Setup Request’: a ‘Shared GTP Tunnel Setup Request: a ‘Shared NG-U GTP Tunnel Setup Request’; and a ‘Shared F1-U GTP Tunnel Setup Request’.

The network node may include at least one of a central unit of the base station apparatus (e.g. gNB-CU) and a core network node for mobility management (e.g. an Access and Mobility Management Function).

The information identifying the tunnel may comprise a Transport Layer Information, which includes a Transport Network Layer (TNL) address and a GPRS Tunnel Endpoint Identifier of the base station apparatus or a distributed unit of the base station apparatus.

At least one of the information identifying the tunnel associated with an MBS session and the information indicating that the tunnel is a shared tunnel may be included in an ‘UP Transport Layer Information’ information element.

The shared tunnel may comprise at least one of a user plane tunnel between a central unit and a distributed unit of the base station apparatus (e.g. an F1-U tunnel) and a user plane tunnel between a core network node and the base station apparatus (e.g. an NG-U tunnel).

The information identifying one or more MBS session to be added and/or the information identifying one or more MBS session to be modified may include at least one of the following, for each MBS session to be added/modified: an MBS context: information identifying associated Quality of Service (QOS) flows; an MBS session identifier: a Temporary Mobile Group Identity (TMGI); a UE identifier (UE ID): uplink (UL) NG-U user plane Transport Network Layer (TNL) Information; and downlink (DL) QoS Flow per TNL Information.

Various other modifications will be apparent to those skilled in the art and will not be described in further detail here.

### LIST OF REFERENCES

[1] 3GPP Technical Specifications (TS) 23.247 V17.0.0
[2] 3GPP TS 23.501
[3] 3GPP TS 37.340 V16.7.0
[4] 3GPP TS 38.300 V16.7.0
[5] 3GPP TS 38.413 V16.7.0
[6] 3GPP TS 38.473 V16.7.0

Although the present invention has been described with reference to the exemplary embodiments, the present invention is not limited to the above. Various changes that can be understood by those skilled in the art can be made to the configuration and details of the present invention within the scope of the invention.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

For example, the whole or part of the exemplary embodiments disclosed above can be described as, but not limited to, the following supplementary notes.

### (Supplementary Note 1)

A method performed by a base station for providing Multicast and Broadcast Services (MBS), the method comprising:
transmitting, to a network node, a message including first information identifying a tunnel associated with an MBS session, wherein the message indicates that the tunnel is a shared tunnel; and
receiving, via the shared tunnel, user plane protocol data unit for the MBS session for transmitting to the UE, upon transmitting the message.

### (Supplementary Note 2)

The method according to supplementary note 1, wherein the message includes second information of the MBS session.

### (Supplementary Note 3)

The method according to supplementary note 1 or 2, wherein the message includes a base station to core network protocol message or a base station distributed unit to central unit protocol message.

### (Supplementary Note 4)

The method according to any one of supplementary notes 1 to 3, wherein the message includes a response to a message requesting setting up of an associated UE context for the UE or a response to a message requesting UE context modification.

### (Supplementary Note 5)

The method according to any one of supplementary notes 1 to 4, further comprising receiving, from the network node, a request including the first information.

### (Supplementary Note 6)

A method performed by a base station for providing Multicast and Broadcast Services (MBS), the method comprising:
receiving, from a network node, a request for setting up for a tunnel associated with an MBS session as a shared tunnel, the request including second information of the MBS session and first information identifying the tunnel; and
receiving, via the shared tunnel, user plane protocol data unit for the MBS session for transmitting to the UE, upon receiving the message.

### (Supplementary Note 7)

The method according to supplementary note 6, wherein the request is non-UE-associated signalling.

### (Supplementary Note 8)

A method performed by a network node for providing Multicast and Broadcast Services (MBS), the method comprising:
receiving, from a base station, a message including first information identifying a tunnel associated with an MBS session, wherein the message indicates that the tunnel is a shared tunnel; and
transmitting, via the shared tunnel, user plane protocol data unit for the MBS session to a user equipment (UE), upon receiving the message.

### (Supplementary Note 9)

The method according to supplementary note 8, wherein the network node includes at least one of a central unit of the base station and a core network node for mobility management.

### (Supplementary Note 10)

A method performed by a network node the method comprising:
transmitting, to a base station for providing Multicast and Broadcast Services (MBS), a request for setting up a tunnel associated with an MBS session as a shared tunnel, the request including second information of the MBS session and first information identifying the tunnel;
wherein the shared tunnel is adapted to be used, by the base station, for transmitting user plane protocol data unit for the MBS session.

### (Supplementary Note 11)

The method according to any one of supplementary notes 1 to 10, wherein the first information includes a Transport Layer Information and a Transport Network Layer (TNL) address of the base station or a distributed unit of the base station.

### (Supplementary Note 12)

The method according to supplementary note 11, wherein the first information is included in an ‘UP Transport Layer Information’ information element.

### (Supplementary Note 13)

The method according to any one of supplementary notes 1 to 12, wherein the shared tunnel includes at least one of:
a user plane tunnel between a central unit and a distributed unit of the base station, and
a user plane tunnel between a core network node and the base station.

### (Supplementary Note 14)

A method performed by a first core network node for managing at least one Multicast and Broadcast Services (MBS) session provided using a shared tunnel, the method comprising:
transmitting a session management message to a second core network node for managing a user plane associated with the at least one MBS session, the message including at least one of:
   information identifying one or more MBS session to be added at the second core network node;
   information identifying one or more MBS session to be modified at the second core network node; and
   information identifying one or more MBS session to be removed at the second core network node.

### (Supplementary Note 15)

A method performed by a second core network node for managing a user plane associated with at least one Multicast and Broadcast Services (MBS) session provided using a shared tunnel, the method comprising:
receiving, from a first core network node, a session management message including at least one of:
   information identifying one or more MBS session to be added at the second core network node;
   information identifying one or more MBS session to be modified at the second core network node; and
   information identifying one or more MBS session to be removed at the second core network node.

### (Supplementary Note 16)

The method according to supplementary note 14 or 15, wherein the information identifying one or more MBS session to be added and/or the information identifying one or more MBS session to be modified includes at least one of the following, for each MBS session to be added/modified:
an MBS context;
information identifying associated Quality of Service (QOS) flows;
an MBS session identifier;
a Temporary Mobile Group Identity (TMGI);
a UE identifier (UE ID);
uplink (UL) NG-U user plane Transport Network Layer (TNL) Information; and
downlink (DL) QoS Flow per TNL Information.

### (Supplementary Note 17)

A base station for providing Multicast and Broadcast Services (MBS), comprising:
means for transmitting, to a network node, a message including first information identifying a tunnel associated with an MBS session, wherein the message indicates that the tunnel is a shared tunnel; and
means for receiving, via the shared tunnel, user plane protocol data unit for the MBS session for transmitting to the UE, upon transmitting the message.

### (Supplementary Note 18)

A base station for providing Multicast and Broadcast Services (MBS), the base station apparatus comprising:
means for receiving, from a network node, a request for setting up a tunnel associated with an MBS session as a shared tunnel, the request including second information of the MBS session and first information identifying the tunnel; and
means for receiving, via the shared tunnel, user plane protocol data unit for the MBS session for transmitting to the UE, upon receiving the message.

### (Supplementary Note 19)

A network node for providing Multicast and Broadcast Services (MBS), comprising:
means for receiving, from a base station, a message including first information identifying a tunnel associated with an MBS session, wherein the message indicates that the tunnel is a shared tunnel; and
means for transmitting, via the shared tunnel, user plane protocol data unit for the MBS session to a user equipment (UE), upon receiving the message.

### (Supplementary Note 20)

A network node comprising:
means for transmitting, to a base station for providing Multicast and Broadcast Services (MBS), a request for setting up a tunnel associated with an MBS session as a shared tunnel, the request including second information of the MBS session and first information identifying the tunnel;
wherein the shared tunnel is adapted to be used, by the base station, for transmitting user plane protocol data unit for the MBS session.

### (Supplementary Note 21)

A first core network node for managing at least one Multicast and Broadcast Services (MBS) session provided using a shared tunnel, the first core network node comprising:
means for transmitting a session management message to a second core network node for managing a user plane associated with the at least one MBS session, the message including at least one of:
   information identifying one or more MBS session to be added at the second core network node;
   information identifying one or more MBS session to be modified at the second core network node; and
   information identifying one or more MBS session to be removed at the second core network node.

### (Supplementary Note 22)

A second core network node for managing a user plane associated with at least one Multicast and Broadcast Services (MBS) session provided using a shared tunnel, the second core network node comprising:
means for receiving, from a first core network node, a session management message including at least one of:
   information identifying one or more MBS session to be added at the second core network node;
   information identifying one or more MBS session to be modified at the second core network node; and
   information identifying one or more MBS session to be removed at the second core network node.

This application is based upon and claims the benefit of priority from United Kingdom patent application No. 2118978.2, filed on Dec. 23, 2021, the disclosure of which is incorporated herein in its entirety by reference.

### REFERENCE SIGNS LIST

1 telecommunication system
3 mobile device
5 base station
7 core network
9 AMF
10 UPF
11 SMF

What is claimed is:

1. A method performed by a distributed unit of a base station for providing Multicast and Broadcast Services (MBS), the method comprising:
transmitting, to a central unit of the base station, a message including first information identifying a user plane tunnel between the central unit and the distributed unit associated with an MBS session, wherein the message indicates that the user plane tunnel is a shared tunnel; and
receiving, via the shared tunnel, user plane protocol data unit for the MBS session for transmitting to a user equipment (UE), upon transmitting the message.

2. The method according to claim 1, wherein
the message includes second information of the MBS session.

3. The method according to claim 1, wherein
the message includes a base station distributed unit to central unit protocol message.

4. The method according to claim 1, wherein
the message includes a response to a message requesting setting up of an associated UE context for the UE or a response to a message requesting UE context modification.

5. The method according to claim 1, further comprising:
receiving, from the central unit, a request including the first information.

6. A method performed by a distributed unit of a base station for providing Multicast and Broadcast Services (MBS), the method comprising:
receiving, from a central unit of the base station, a request for setting up for a user plane tunnel between the central unit and the distributed unit associated with an MBS session as a shared tunnel, the request including second information of the MBS session and first information identifying the user plane tunnel; and
receiving, via the shared tunnel, user plane protocol data unit for the MBS session for transmitting to a user equipment (UE), upon receiving the message.

7. The method according to claim 6, wherein
the request is non UE-associated signalling.

8. A method performed by a central unit of a base station for providing Multicast and Broadcast Services (MBS), the method comprising:
receiving, from a distributed unit of the base station, a message including first information identifying a user plane tunnel between the central unit and the distributed unit associated with an MBS session, wherein the message indicates that the user plane tunnel is a shared tunnel; and
transmitting, via the shared tunnel, user plane protocol data unit for the MBS session to a user equipment (UE), upon receiving the message.

9. (canceled)

10. A method performed by a central unit of a base station, the method comprising:
transmitting, to a distributed unit of the base station for providing Multicast and Broadcast Services (MBS), a request for setting up a user plane tunnel between the central unit and the distributed unit associated with an MBS session as a shared tunnel, the request including second information of the MBS session and first information identifying the tunnel;
wherein the shared tunnel is configured to be used, by the distributed unit, for transmitting user plane protocol data unit for the MBS session.

11. The method according to claim 1, wherein
the first information includes a Transport Layer Information and a Transport Network Layer (TNL) address of the distributed unit.

12. The method according to claim 11, wherein the first information is included in an ‘UP Transport Layer Information’ information element.

13. (canceled)

14. A method performed by a first core network node for managing at least one Multicast and Broadcast Services (MBS) session provided using a shared tunnel, the method comprising:
transmitting, to a second core network node for managing a user plane associated with the at least one MBS session, a session management message including information identifying one or more MBS session to be added at the second core network node, in a case where the shared tunnel has not been established yet.

15. A method performed by a second core network node for managing a user plane associated with at least one Multicast and Broadcast Services (MBS) session provided using a shared tunnel, the method comprising:
receiving, from a first core network node for managing the at least one MBS session, a session management message including information identifying one or more MBS session to be added at the second core network node, in a case where the shared tunnel has not been established yet.

16. The method according to claim 14 or 15, wherein
the information identifying one or more MBS session to be added includes at least one of the following, for each MBS session to be added:
an MBS context;
information identifying associated Quality of Service (QOS) flows;
an MBS session identifier;
a Temporary Mobile Group Identity (TMGI);
a UE identifier (UE ID);
uplink (UL) NG-U user plane Transport Network Layer (TNL) Information; and
downlink (DL) QoS Flow per TNL Information.

17. A distributed unit of a base station for providing Multicast and Broadcast Services (MBS), the distributed unit comprising:
at least one memory storing instructions; and
at least one processor configured to process the instructions to:
transmitting, to a central unit of the base station, a message including first information identifying a user plane tunnel between the central unit and the distributed unit associated with an MBS session, wherein the message indicates that the user plane tunnel is a shared tunnel; and
receive, via the shared tunnel, user plane protocol data unit for the MBS session for transmitting to a user equipment (UE), upon transmitting the message.

18. A distributed unit of a base station for providing Multicast and Broadcast Services (MBS), the distributed unit comprising:
at least one memory storing instructions; and
at least one processor configured to process the instructions to:
receive, from a central unit of the base station, a request for setting up a user plane tunnel between the central unit and the distributed unit associated with an MBS session as a shared tunnel, the request including second information of the MBS session and first information identifying the user plane tunnel; and
receive, via the shared tunnel, user plane protocol data unit for the MBS session for transmitting to a user equipment (UE), upon receiving the message.

19. A central unit of a base station for providing Multicast and Broadcast Services (MBS), the central unit comprising:
at least one memory storing instructions; and
at least one processor configured to process the instructions to:
receive, from a distributed unit of the base station, a message including first information identifying a user plane tunnel between the central unit and the distributed unit associated with an MBS session, wherein the message indicates that the user plane tunnel is a shared tunnel; and
transmit, via the shared tunnel, user plane protocol data unit for the MBS session to a user equipment (UE), upon receiving the message.

20. A central unit of a base station comprising:
at least one memory storing instructions; and
at least one processor configured to process the instructions to:
transmit, to a distributed unit of the base station for providing Multicast and Broadcast Services (MBS), a request for setting up a user plane tunnel between the central unit and the distributed unit associated with an MBS session as a shared tunnel, the request including second information of the MBS session and first information identifying the tunnel;
wherein the shared tunnel is configured to be used, by the distributed unit, for transmitting user plane protocol data unit for the MBS session.

21. A first core network node for managing at least one Multicast and Broadcast Services (MBS) session provided using a shared tunnel, the first core network node comprising:
at least one memory storing instructions; and
at least one processor configured to process the instructions to:
transmit, to a second core network node for managing a user plane associated with the at least one MBS session, a session management message including information identifying one or more MBS session to be added at the second core network node, in a case where the shared tunnel has not been established yet.

22. A second core network node for managing a user plane associated with at least one Multicast and Broadcast Services (MBS) session provided using a shared tunnel, the second core network node comprising:
at least one memory storing instructions; and
at least one processor configured to process the instructions to:
receive, from a first core network node for managing the at least one MBS session, a session management message including information identifying one or more MBS session to be added at the second core network node, in a case where the shared tunnel has not been established yet.
